(19) United States
(12) Patent Application Publication
(10) Pub. No.: US 2009/0214103 A1
(43) Pub. Date: Aug. 27, 2009

(54) METHOD FOR MEASURING A PATTERN DIMENSION

(75) Inventors: Maki Tanaka, Mito (JP); Chie Shishido, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi High-Technologies Corporation

(21) Appl. No.: 12/370,941

(22) Filed: Feb. 13, 2009

(30) Foreign Application Priority Data
Feb. 22, 2008 (JP) 2008-040817

(51) Int. Cl. G06K 9/00

(52) U.S. Cl. 382/145; 382/207

(57) ABSTRACT

In SEM image based pattern measurement using electron beam simulation, accuracy of simulation is very influential. For matching between a simulated image and an actual image, it is needed to properly model the shape and material of a target being measured and reflect them in simulated images. In the present invention, highly accurate pattern measurements are achieved by using simulated images with properly set parameters of shape and dimension having a large influence on the accuracy of matching for measurement between simulated and actual images, based on SEM images or information obtained by another measurement apparatus such as AFM.

### CLAIM OF PRIORITY

The present application claims priority from Japanese application serial no. JP2008-040817, filed on Feb. 22, 2008, the content of which is hereby incorporated by reference into this application.

### Background of the Invention

The present invention relates to a method and system for evaluating whether the geometry of a circuit pattern formed on a wafer is accurate using an electron microscopic image of the circuit pattern.

In a semiconductor wafer manufacturing process, multi-layered patterns formed on a wafer tend to become finer and finer rapidly. The importance of a process monitor to monitor whether the patterns are formed conformable to design on the wafer increases more and more. Among others, for line patterns including transistor gate pattern, as there is a strong relationship between a line width and device electrical characteristics, it is especially important to monitor the patterning process.

As a length measuring tool for measuring line widths on the order of several tens of nanometers in very fine wiring, a scanning-type electron microscope for line width measurement (length measurement SEM (Scanning Electron Microscope) or a CD (Critical Dimension) SEM capable of capturing an image of such wiring magnified by a factor of from one to two hundred thousand has heretofore been used. An example of a length measurement process using such a scanning-type electron microscope is described in JP-A No. Hei 11-316115. In the example disclosed in this patent document 1, from within a local region in a captured image of wiring under measurement, a projected profile is created by adding and averaging signal profiles of wiring in a longitudinal direction of the wiring. The wiring dimension is calculated as a distance between the wiring edges in a lateral direction detected in the projected profile.

However, in J. S. Villarrubia, A. E. Vladar, J. R. Lowney, and M. T. Postek, “Scanning electron microscope analog of scatterometry,” Proc. SPIE 4689, pp. 304-312 (2002) (Hereinafter mentioned as Document 1), as disclosed in FIG. 1, in a signal waveform of SEM, the following problem appears: as a measurement target shape changes, the signal waveform changes accordingly, thus resulting in a linewidth measurement error. As semiconductor patterns become finer and finer, such measurement error would have more significant effect on the process monitor. A method for reducing such measurement error is disclosed in the above-mentioned Document 1 and J. S. Villarrubia, A. E. Vladar, M. T. Postek, “A simulation study of repeatability and bias in the CD-SEM,” Proc. SPIE 5038, pp. 138-149, 2003 (hereinafter mentioned as Document 2). In this method, a relationship between a pattern shape and a SEM signal waveform is calculated in advance by simulation. Using the thus calculated relationship, this method accomplishes measurement with high accuracy, not depending on target shape.

When measuring a sample in which the material of a pattern and the material of a substrate surface layer on which the pattern is formed have different secondary electron emission efficiencies, in-advance adjustment of the parameters of the materials contributes to improving the accuracy of measurement based on library matching. This approach is disclosed in M. Tanaka, J. S. Villarrubia and A. E. Vladar, “Influence of Focus Variation on Linewidth Measurements,” Proc. SPIE 5752, pp. 144-155(2005) (hereinafter mentioned as Document 3).

As already stated for background technology, when measuring the dimensions of semiconductor patterns by length measurement SEM, a problem arises that a measurement error depending on target pattern shape occurs. To address this problem, the method described in Document 1 and Document 2 calculates in advance a relationship between a pattern shape and a SEM signal waveform by simulation. Using the thus calculated relationship, this method accomplishes measurement with high accuracy, not depending on target shape. Using parameters representing pattern shapes in terms of values, results of simulation for a variety of shapes are stored in a library. Comparing a waveform obtained from actual SEM image for measurement against the library, it is possible to estimate a shape and its dimensions accurately. This method is termed herein as a model-based measurement or library matching method. In the model-based measurement method, how to perform accurate simulation is a key to achieving stable and highly accurate measurement.

To obtain simulation results suitable for comparison with an image obtained from actual measurement for a match, it is important to use appropriate models of pattern shapes and set simulation parameters properly. However, optimal models of pattern shapes differ from actual shape of targets of measurement and it is difficult to set these models simply and appropriately. As another problem, there is a difficulty in accurately determining physical parameters used in the model such as material properties of measurement targets.

A further problem is that, in a process of matching against the library, it is time-consuming to look for an optimal combination of a number of parameters, even if suitable shape models are available in the library. Instead of the time-consuming full search throughout the parameter space, any of diverse nonlinear optimization methods can be used. In the latter case, the outcome is likely to be a local solution and it would be difficult to obtain a correct measurement result. Summary of the Invention

To tackle the above-noted problems, in the present invention, by estimating material and shape models and parameters of a target sample being measured based on results of estimation made beforehand by another means, the invention intends to enhance the measurement method using simulation described in Document 1 and Document 2 in terms of accuracy, speed, and accuracy.

In the present invention, distances to neighboring patterns having a large influence on dimension measurements are estimated based on conventional measurement method using an actual SEM image. Highly accurate measurements are achieved by executing library matching using simulated waveforms obtained only under a condition of estimated distance to neighboring patterns.

Similarly, for a line width of a pattern, estimation is made based on conventional measurement method using an actual SEM image. Highly accurate measurements are achieved by executing library matching using simulated waveforms obtained only under a condition of estimated line width.

Further, based on relationships between pattern shapes and SEM image feature values, obtained beforehand by simulation, a pattern shape of a measurement target is estimated using image feature values obtained from a measured SEM image of a target pattern based on the relationships. Results of estimation are used as initial values for library matching. In this way, fast and stable matching is executed and highly accurate and fast measurements are achieved.

In a further method, based on information obtained beforehand by another measurement apparatus such as AFM, initial values of pattern geometry parameters are appropriately set for library matching. In this way, fast and stable matching is executed and highly accurate and fast measurements are achieved.

For shape model optimization, a graphical user interface is provided which allows the operator to select an optimal shape model and set parameters easily, based on cross-sectional shape information obtained by AFM, cross-section SEM, and the like. Consequently, stable and highly accurate measurements are achieved.

For measurement of a pattern made of a plurality of materials, a SEM image is obtained beforehand and, when a library is created, material parameters are set so that a signal quantity ratio between each material in simulation accords with a contrast in the actual SEM image. In this way, the accuracy of simulation is improved and stable and highly accurate measurements are achieved.

According to the present invention, it is possible to improve the accuracy of simulation for use in a model-based measurement method. In consequence, the accuracy of model-based measurement method itself is improved. By setting material parameters and some shape parameters in advance, the number of parameters to be estimated can be reduced. Accordingly, stable estimations can be made and the calculation time for measurement can be reduced. Additionally, by using proper initial values of parameters that have to be estimated, stable and fast estimations can be made and, consequently, the reliability and speed of measurement can be enhanced.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1A is a diagram schematizing a system including a scanning electron microscope;

FIG. 1B is a flowchart describing a procedure of measurement using SEM involved in a first embodiment;

FIG. 2A is a diagram to explain a drawback of conventional library matching methods, representing that a SEM signal waveform Wf in an edge portion changes significantly with change of space width S between a pattern 201 and a pattern 202, which is enlarged and shown at the right;

FIG. 2B is a graph representing that input patterns have uniform width dimension W and height dimension H, but results of measurment using a threshold scheme vary in relation to the space width S between the pattern 201 and the pattern 202;

FIG. 2C shows a SEM image including target patterns being measured;

FIG. 3A shows a SEM image including a target pattern being measured;

FIG. 3B shows a SEM signal waveform in the x direction passing across measurement windows;

FIG. 4A is a graph showing a relationship between space width (x axis) of a pattern and the pattern measurement (y axis) obtained by the same conventional method as used for tentative space measurements;

FIG. 4B presents an example of a library of simulated waveforms for use in the present invention;

FIG. 5A schematically shows a SEM signal waveform for a pattern with a larger dimension;

FIG. 5B schematically shows a SEM signal waveform for a pattern with a dimension somewhat smaller than that shown in FIG. 5A;

FIG. 5C schematically shows a SEM signal waveform for a pattern with an even smaller dimension than that shown in FIG. 5B;

FIG. 5D is a flowchart describing a procedure of measurement using SEM involved in a second embodiment;

FIG. 6A is a graph representing a library matching error space;

FIG. 6B is a flowchart describing a procedure of measurement using SEM involved in a third embodiment;

FIG. 7A is a diagram showing a relationship between a cross-sectional shape of a pattern and feature values in a SEM image signal waveform of the pattern;

FIG. 7B is a diagram showing a relationship between a cross-sectional shape of a pattern, a SEM image signal waveform and its first-order differential waveform of the pattern, and its feature values;

FIG. 8A presents graphs plotting distribution of image feature values in a geometry parameter space on curved surfaces 801 and 802;

FIG. 8B presents graphs showing planes 803 and 804 obtained by calculating image feature values from actually measured SEM image;

FIG. 8C presents graphs wherein a likelihood function of each parameter according to a distance of the curved surface 801 or 802 from the plane 803 or 804 is given appropriately;

FIG. 8D presents a graph showing an estimated geometry obtained by combining the graphs for each feature value;

FIG. 9 is a flowchart describing a procedure of measurement using SEM involved in a fourth embodiment;

FIG. 10A shows a cross section view of a pattern shape model;

FIG. 10B shows a cross section view of a pattern shape model in which one trapezoid is on top of another trapezoid;

FIG. 10C shows a shape model suitable for resist patterns made by a combination of a trapezoid and an ellipse;

FIG. 10D shows an example of a graphical user interface allowing the user to select a shape model and set parameters, while viewing a cross-section photograph;

FIG. 11A shows a cross section of a pattern and a substrate surface layer made of different materials;

FIG. 11B shows a SEM image signal waveform of the pattern shown in FIG. 11A;

FIG. 11C shows a simulated SEM image signal waveform of the pattern shown in FIG. 11A; and

FIG. 11D is a graph to explain adjustment of relative brightness between materials so that contrast between materials accords with an actual image.

### DESCRIPTION OF THE PREFERRED EMBODIMENTS

While the present invention is applicable to several types of charged particle radiation apparatus (SEM, FIB, etc.) the following description of embodiments relates to a typical case where SEM is used by way of example.

### First Embodiment

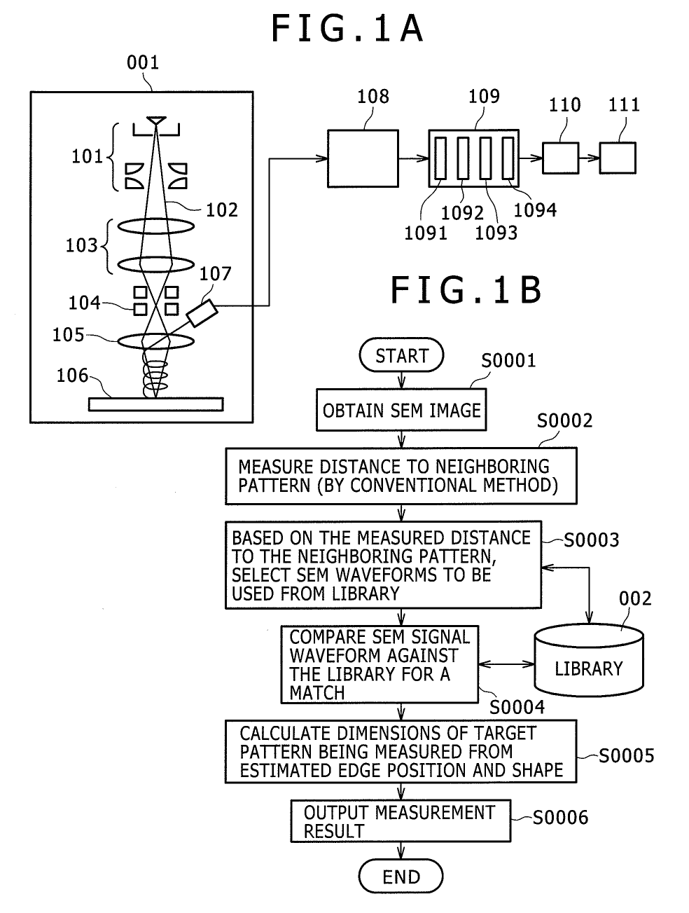

In a first embodiment, descriptions are provided for a method for reducing SEM measurement errors resulting from variation of spaces around a target pattern being measured, that is, distances neighboring patterns, using FIGS. 1 through 5. The method of the present invention, based on tentative measurements of spaces made beforehand by a conventional method, restricts simulation waveforms for use in waveform matching in a library to those suitable for an actually measured pattern, thereby improving the accuracy of matching and eventually the accuracy of pattern measurement.

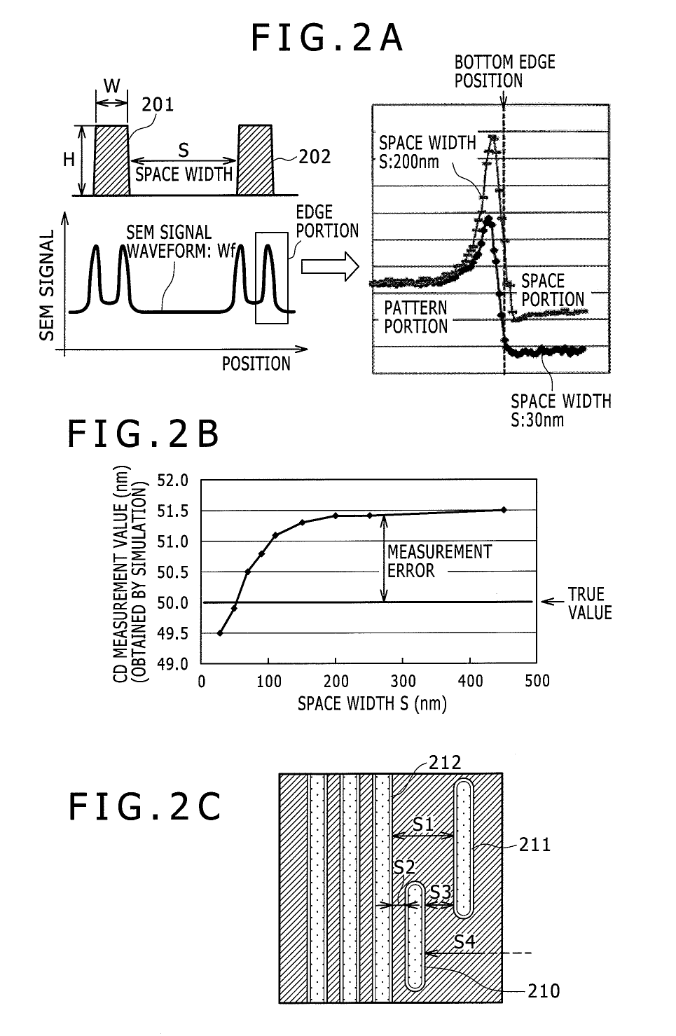

FIGS. 2A-2C are diagrams to explain a measurement error emerging depending on space, which is a problem involved in the measurements made by conventional methods. As shown in a graph of FIG. 2A, a SEM signal waveform Wf in an edge portion changes significantly with change of space width S between a pattern 201 and a pattern 202, which is enlarged and shown at the right. This phenomenon is due to that secondary electrons produced from the space portion collide against the sidewall of the edge and consequently the amount of detected signals decreases. This phenomenon is noticeable when the pattern is higher and the space is narrower. FIG. 2B plots measurement values obtained by a conventional threshold scheme (a threshold value of 50%) when the space width S is varied, measured with simulated SEM signal waveforms.

The threshold scheme is such that an arbitrary brightness between a signal quantity at the substrate surface and a signal quantity at the peak of the edge portion is specified by a threshold value with the substrate surface having 0 and the peak having 100%. A position having a signal quantity corresponding to the specified threshold value is determined to be a pattern edge position. In FIG. 2B, input patterns have uniform width dimension W and height dimension H, but measurment results vary in relation to the space width S between the pattern 201 and the pattern 202. Although depending on the dimensions W and H of target patterns being measured, the error range may extend from several nanometers to ten and several nanometers.

Meanwhile, in a view of patterns which are actually measured, there are typically varied distances between adjacent patterns, defined by layout, as denoted by arrows in FIG. 2C. In an example shown in FIG. 2C, patterns 210, 211, 212 are spaced from each other, the respective distances between them being S1 to S4. From this, it is understood that taking the influence of the spaces into consideration is important for enhancing the accuracy of measurement.

As a solution to this drawback, a procedure of measurement using SEM for a first embodiment of a pattern measurement method according to the present invention is described in FIGS. 1A and 1B.

Before starting the measurement, SEM simulations are performed with a variety of values set for the shapes and dimensions of patterns and distances between adjacent patterns and SEM simulated waveforms are stored in a library. Parameters for simulation should be set appropriately in a certain range depending on a manufacturing process for patterns to be measured.

When a measurement is performed, first, a SEM image of a sample is obtained by a SEM 001 shown in FIG. 1A under preset conditions of image capturing (such as such as a magnifying factor and an accelerating voltage of an irradiation beam). In particular, an electron beam 102 emitted from an electron gun 101 of the SEM 001 is converged by condenser lenses 103 and directed by a deflector 104 for scanning in X and Y directions (in a plane vertical to the drawing in FIG. 1A corresponding to the surface of the sample 106). By an objective lens 105, the electron beam is focused on the surface of a sample 106 on which patterns to be measured are formed. Thus, the electron beam irradiates, while scanning the surface of the sample. Although not shown in FIG. 1A, the sample 106 is placed on a table so as to be movable in a plane and controlled so that a desired region on the surface of a sample 16 is positioned to be the region irradiated by the electron beam 10. Secondary electrons developed from the surface of the sample 106 irradiated by the electron beam 102 are in part detected by a detector 107, converted into electric signals, and sent to an overall control and image processor 108 where a SEM image is created. Then, the SEM image is processed by an arithmetic processor 109 where target pattern dimensions are calculated and results are displayed on a screen of an output unit 110. The overall control and image processor 108 also exerts an overall control of the SEM 001 including the table (not shown) on which the sample 106 is placed.

A procedure for processing by the arithmetic processor 109 is described in FIG. 1B. As described above, first, the overall control and image processor 108 controls the SEM 001 and obtains a SEM image of patterns to be measured (S0001). Then, the arithmetic processor 109 receives the SEM image obtained by the overall control and image processor 108 and processes the SEM image. The arithmetic processor 109 tentatively measures a dimension of a target pattern being measured and distances from the target pattern to its neighboring patterns (S0002). The measurement in this step (S0002) may be performed by a conventional edge detection method such as the threshold scheme.

Based on the distances to the neighboring patterns measured in the step (S0002), the arithmetic processor then selects simulated waveforms with a space length corresponding to that of an actual space measured in the step (S0002) from a library of SEM simulated waveforms calculated beforehand (S0003). The thus selected simulated waveforms are used for matching.

Then, using only the selected waveforms from the library in the step (S0003), the arithmetic processor executes library matching; i.e., it compares the actually measured waveform of the target pattern to the selected waveforms for a match (S0004). It estimates the position and shape of a sidewall edge of the pattern from the input shape of the most matched simulated waveform. Based on the estimated edge position and shape of the target pattern obtained as matching results, the arithmetic processor calculates a dimension of the pattern at a height previously specified by a user (S0005). Finally, obtained results are displayed as a SEM image or numeric data on the screen of the output unit 110 (S0006). Output from the output unit 110 may be sent to another data processing device or storage device which is not shown.

In the following, each step in FIG. 1B is detailed in further detail.

Setting Processing Regions and Initial Measurements by a Conventional Method

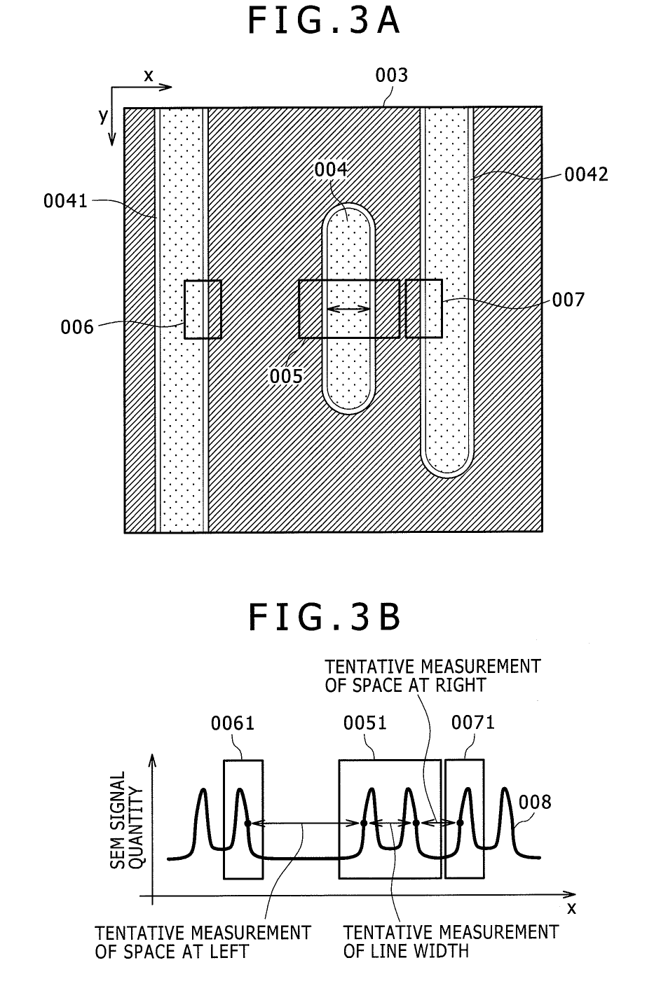

Measuring distances to neighboring patterns described in the step S0002 is explained in further detail, using FIGS. 3A AND 3B. Measurement of distances to neighboring patterns is executed by an image processing unit 1091 in the arithmetic processor 109 and an image within preset regions is subjected to the processing. FIG. 3A presents an example of setting processing region defining windows in a SEM image 003 of a target being measured. In this setting example, a dimension measurement processing region 005 is set traversing a target pattern being measured 004 in the center of the image and space measurement processing regions 0041 and 0042 are set across an edge of each of neighboring patterns 0041 and 0042 which are positioned at left and right to the target pattern. These processing region defining windows may be set by an operator viewing an actual SEM image or may be automatically set from pattern design information, if available. These windows may be set as a measurement recipe previously, so that the windows can be set automatically for a sample on other wafers and shots by positioning patterns.

FIG. 3B shows a SEM signal waveform 008 in the x direction passing across the measurement windows. Processing is performed on the SEM image in the processing region defining windows 005, 006, 007 set as in FIG. 3A (the regions corresponding to portions 0051, 0061, 071 of the signal waveform in FIG. 3B). For this processing, a plurality of SEM signal waveforms may be averaged and an average waveform may be used as preprocessing to improve the S/N ratio of the image to be processed. For example, in the case of line patterns as shown in FIG. 3A, longitudinal dimensions and edge shapes of these line patterns do not vary much in local regions. Hence, a waveform obtained by averaging image data for a plurality of pixels at different y coordinates in the image may be subjected to the processing. Alternatively, of course, averaging may be performed with regard to varying dimensions of the patterns, as disclosed in non-patent document 3.

Once the processing regions in the SEM image have been determined in this way, edge detection by a conventional method is performed in these regions in the step S002, thereby measuring a dimension of the target pattern being measured and distances to its neighboring patterns. By way of example, in the waveform shown in FIG. 3B, edge positions detected applying a threshold value of 50% are marked by dots. By calculating distances between the thus extracted edge positions, it is possible to tentatively determine the dimension of the target pattern and the distances to the neighboring patterns, as denoted by arrows in the graph of FIG. 3B.

Although the threshold scheme is used as the edge extraction method in this case, other measurement methods which are commonly used may be used, of course. Other methods for determining edge positions include detecting peak positions in signal quantity (equivalent to a threshold value of 100%) for patterns for which sufficiently fast processing is possible, calculating maximum and minimum differential values in signal quantity, and determining points at which a line fit to data obtained from the sidewalls intersecting the brightness of the substrate surface.

Although the example shown in FIG. 3A represents the case that neighboring patterns exist at left and right to the target pattern, if no neighboring pattern is observed in the range of the SEM image, the measurement is not performed. Instead, the process proceeds to the following step, using design values of preset values.

As can be seen in FIG. 2B, the smaller the space between patterns, the SEM waveform will be affected more significantly by the space-dependent measurement error. For this reason, if some large space exists between patterns, the influence on subsequent processing is reduced to a level not causing a problem, even if the actual space width is not determined exactly. It will be expedient to previously define a range of space widths affecting the accuracy of measurement, so that switching to design values or the like may be performed for a space width more than the range.

For example, in the graph shown in FIG. 2B, in a high sensitivity domain with regard to measurement error variation with change of space width, it will be expedient to obtain an image with a field of view in which space measurement can be ensured and use an accurate value of space measurement. In a low sensitivity domain, design values may be used. In a domain of error saturation, results of simulation using preset fixed values maybe used. Avoiding the use of design values for narrower spaces is because the narrower spaces are sensitive to errors depending on space width and because the narrower the space provided, the lower will be conformability to design values.

Library Creation and Limiting the Scope of Matching

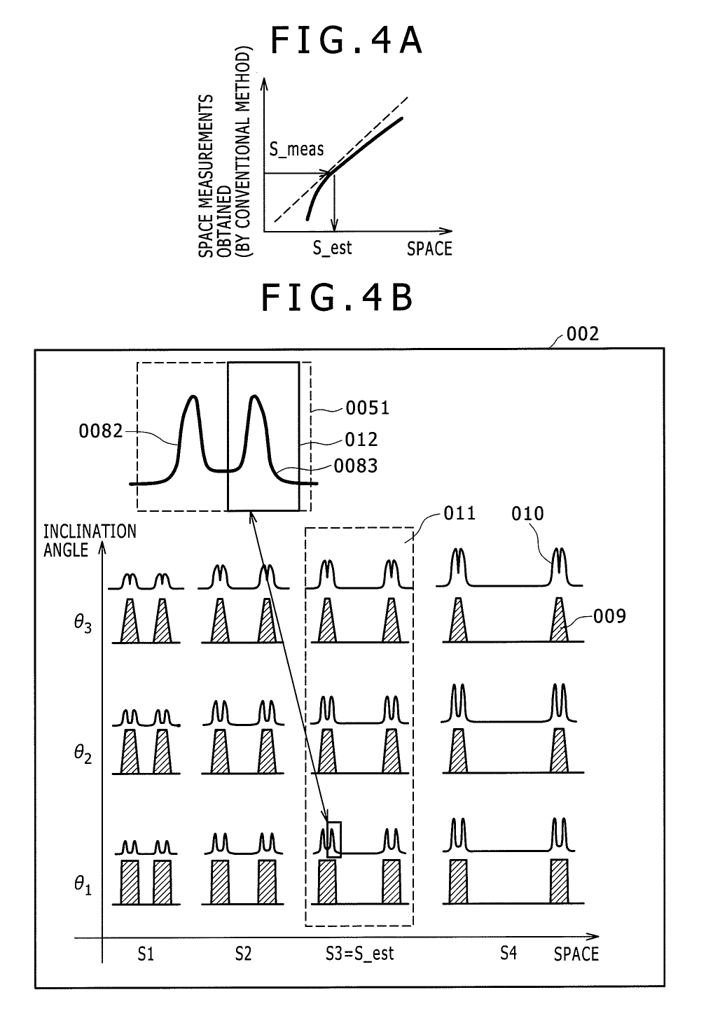

Then, a method of creating a library which is used in the present invention and a method of limiting the scope of matching in the library, using the space widths tentatively measured by the step S0003, are explained using FIGS. 4A and 4B. Creating the library is performed by a simulation unit 1092 in the arithmetic processor 109.

FIG. 4A shows a relationship between space width (x axis) of a pattern and the pattern measurement (y axis) obtained by the same conventional method as used for tentative space measurements, which can be derived from the graph of FIG. 2B. This graph can be created easily by performing the conventional measurement process with respect to waveform data in a library of simulated waveforms. If the relationship shown in FIG. 4A is known, an actual space width (S_est) can be estimated to a certain degree of accuracy from the tentative measurements (S_meas) obtained in the step S0002. In this way, after an actual space width is estimated, waveform matching for measurement is performed with the scope of matching being limited to patterns having the estimated space width selected from the library of simulated waveforms.

Library matching of the present invention and a method for limiting the scope of matching in the library are explained, using FIG. 4B. FIG. 4B presents an example of a library 002 of simulated waveforms for use in the present invention. In the library 002 of simulated waveforms, cross-sectional shapes 009 which are inputs for simulation and SEM simulated waveforms 010 corresponding to the respective shapes are retained.

For library matching measurement that exactly measures varying sidewall inclination angles θ, simulation is performed for shapes with a plurality of different inclination angles θ. In this example, simulated waveforms with regard to three sidewall inclination angles θ are presented for simplifying purposes. In practice, however, simulation may be performed for a certain number of inclination angles in a range covering pattern shapes that may be created due to process variation, wherein the number of sidewall inclination angles depends on desired measurement accuracy. The library of simulated waveforms is created beforehand, separately from the measurement described in FIGS. 1A and 1B. In the present invention, this library includes simulated waveforms obtained by simulation performed with varying space widths S as denoted on the abscissa in FIG. 4B.

Waveforms for two neighboring patterns are shown in FIG. 4B for easy understanding. However, because simulated patterns across a space are identical and only mirrored horizontally, the space up to either one of neighboring patterns may be calculated and stored in the library which is practically created. When matching is performed, a simulation signal may be reversed horizontally as required according to the position of the pattern for which matching is done.

In the present invention, SEM simulation is performed with regard to a combination of geometry parameters as above and each simulated waveform 010 is associated with its shape information 009 and stored in the library 002. Although only waveform examples for varying space widths and inclination angles are presented in FIG. 4B for simplifying purposes, other simulated data with varying rounding values of top corner Rt and bottom corner Rb of patterns may be included in the library, of course (in the latter case, simulated waveforms are obtained in a multidimensional space in three or more dimensions).

In the present invention, by applying an actual space width estimated by the processing according to FIG. 4A to the library 002, the scope of matching is limited in the library 002. In FIG. 4B, an example where the estimated space width S_est matches S3 is presented. Simulated waveforms enclosed in a dotted section, obtained by calculation with a space width equaling the actual space width S_est are only selected. This dotted section is taken as a partial library 011 for use as the scope of matching. By using such a partial library for matching, it becomes possible to achieve a highly accurate measurement taking space-dependent SEM waveform variation into consideration.

The example of FIG. 4B represents a case where a simulation condition is simply selected for simplifying purposes. However, in some cases, simulation data for a space width completely equaling the estimated space width may not be found, because, in practice, simulation conditions which can be prepared beforehand are limited and geometry parameter values in the library are discrete. Thus, in practice, it will be expedient to select a space condition nearest to the estimated value S_est from the library of simulated waveforms or interpolate waveforms near to the SEM waveform at S_est in term of the condition and estimate matched waveforms.

Interpolation of simulated waveforms can be performed by interpolating the waveforms. For example, if there are a simulated waveform for a space of 50 nm, f_s50(x) and a simulated waveform for a space of 100 nm, f_s100(x), a waveform for a space of 80 nm, f_s80(x) can be obtained by linear interpolation as follows: f_s80 (x)=f_s50 (x)+(f_s100(x)−f_s50(x))*(80−50)/(100−50).

For some data in the library, nonlinear interpolation using a combination of two or more space parameters may be performed, of course. Use of interpolation enables the following: if waveforms corresponding to the estimated space value are not found in the library in the step S0003, it may be possible to alternatively use a library of waveforms corresponding to the space value (S_est) created by the above interpolation processing using waveforms for space values around the estimated value.

Library Matching

Then, the image of the actually measured target pattern is compared to the waveforms in the limited scope of the library of simulated waveforms selected in the step S0003. Thus, the most matched waveform in the library is selected. This library matching is performed by a matched waveform selecting unit 1093 in the arithmetic processor 109. In pattern dimension measurement, a distance between both edges of a pattern varies depending on the target being measured (this edge-to-edge distance corresponds to the dimension to be measured). If matching processing is performed entirely for a SEM waveform within the measurement processing window 005 which includes two edeges in FIG. 3B, simulated waveforms for varying edge-to-edge distances are also required and a large amount of calculation is required for matching.

Therefore, in the measurement method of the present invention, out of a SEM signal waveform 0082 in the region 0051 for evaluating one pattern a processing region 012, a local SEM signal waveform 0083 around the target edge for processing is extracted as shown in FIG. 4B. After that, for each edge, waveform matching S0004 against the library is performed by searching from the forgoing limited scope of the library for a simulated waveform in which the waveform of the edge portion most matches the corresponding edge waveform in the actual SEM image S008 in the window for evaluation. At this time, by estimating the x coordinate of the simulated waveform at the same time, not only the shape, but also the position of each edge can be determined exactly.

The degree of agreement in matching between waveforms may be determined by using, for example, a sum of squares of a difference between the waveforms; a simulated waveform having the least value of the above sum may be selected. As noted with respect to the step of limiting the scope of matching in terms of space width in discrete waveforms in the library as illustrated in FIG. 4B, it is also possible to define parameter values not existing in the library as the scope of matching by executing interpolation processing. If parameter values can be handled as a continuous function by interpolation processing, a matched parameter value can be estimated by using a nonlinear optimization method such as a Levenberg-Marquardt algorithm.

Through the above procedure, by determining a simulation condition in which a simulated waveform most matches the actual waveform, the cross-sectional shape and the position of the sidewall of each edge can be estimated with high accuracy. As for the example illustrated in FIG. 4B, from the matching result, for example, for an edge in the captured SEM image, its cross-sectional shape is estimated to match a simulated waveform which is near to space S3 and sidewall inclination angle 01. The edge position in the SEM image can be determined from position offsets of the simulated waveform matched with a partial waveform in the library matching region 012. Since the sidewall shape of the estimated edge can thus be obtained, it becomes possible to calculate the pattern dimension at an arbitrary height. This processing is performed by a pattern dimension calculating unit 1094 in the arithmetic processor 109.

If you specify beforehand a sample height (such as top, bottom, middle, or 10% of pattern height from the bottom) at which you want to obtain a measurement, from the obtained cross-sectional shape, the pattern dimension can be determined from a difference between the edge position and the opposite edge position at the specified height (step S0005). As noted above, matching is performed separately for the left and right edges of a pattern. For each edge, after limiting the scope of matching in the library for an appropriated space, measurement processing is performed. Thus, it becomes possible to perform an accurate measurement even for an asymmetric pattern shape.

After the foregoing processing, the dimension data for an arbitrary height of the target pattern and information for the cross-sectional shape of the pattern can be displayed on the screen of the output unit 110 and provided to the user. Information from the output unit 110 may be transmitted via a communication means and stored on a data server 111.

As described above, the first embodiment of the present invention, if applied, enables accurate dimension and shape measurements of a pattern independent of pattern shape and distances to neighboring patterns. In the present embodiment, it is necessary to carry out a large number of simulations for advance preparation. However, creating a library is necessary only once for each product manufacturing process and recalculation is not required later. Therefore, particularly, in a mass production line, the advantageous effect of the present invention is noticeable, when the invention is applied to measurements of dimensions and shapes of patterns and used for process management.

### Second Embodiment

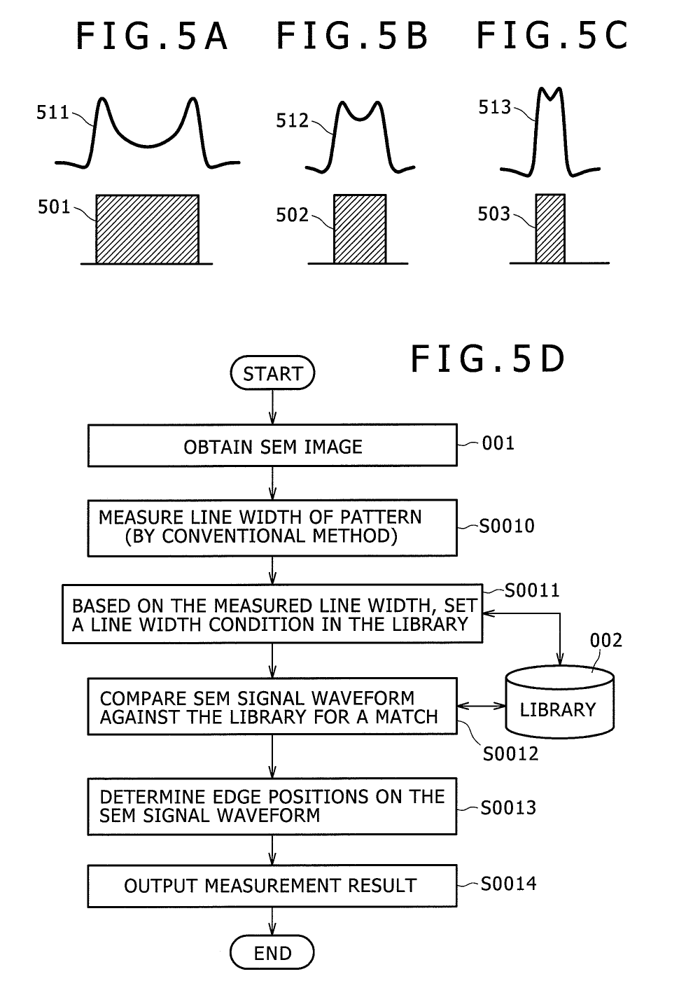

A second embodiment of the present invention is described using FIGS. 5A-5C. FIGS. 5A-5C schematically depict SEM signal waveforms varying with different pattern dimensions. FIG. 5A shows a waveform for a pattern 501 with a larger dimension, FIG. 5B shows a waveform for a pattern 502 with a dimension somewhat smaller than that shown in FIG. 5A, and FIG. 5C shows a waveform for a pattern 503 with an even smaller dimension. As the pattern dimension becomes smaller in order of FIGS. 5A-5C, the quantity of the signal corresponding to the top surface of the pattern largely changes as denoted by 511, 512, and 513. This is attributable to increase of secondary electrons produced with decrease of pattern line width. This is because, when the pattern line width becomes smaller relative to the extension of diffusion of electrons in the sample material, electrons irradiating the center of the pattern diffuse to both edges.

In some combinations of a pattern dimension and its material and a condition of electron beam irradiation, SEM signal waveform variation in an edge portion appears depending on not only space width, as stated in the first embodiment, but also pattern dimension. This situation has an unnegligible influence on the accuracy of measurements of patterns which become finer and finer in recent years. In such condition, measurement taking interference with left and right edges into consideration is required.

The second embodiment copes with the problem of SEM signal waveform change depending on not only space width, but also pattern dimension as shown in FIGS. 5A-5C. This embodiment is explained using FIG. 5D. The procedure of FIG. 5D is the same as the procedure in FIG. 1B for the first embodiment, except that steps S0010, S0011 replace the steps S0002, 0003 described in FIG. 1B.

In the second embodiment, a library containing simulated waveform data for varying dimension widths is initially prepared in the same way as simulated waveform library creation for space widths in the first embodiment. The width of a target pattern is tentatively measured by a conventional method beforehand (S0001). Based on a measurement error between an actual dimension and a dimension measured by the conventional method, which has been obtained beforehand from simulation results, an actual dimension value is predicted from the tentatively measured pattern dimension. Based on the thus predicted pattern dimension, a line width condition is set in the library to limit the scope of matching (S0011). The actual SEM waveform is compared against the limited scope of the library for a match (S0012). Dimension measurement is performed (S0013) and the measurement result is output (S0014). In this case, again, if there appears only a small change in waveforms and measurement errors with dimension variation, design values or predefined fixed values may be used without a problem as in the first embodiment.

As described above, the second embodiment of the present invention, if applied, enables accurate dimension and shape measurements of a pattern that is so fine that interference with left and right edges appears in a SEM image, in addition to the advantageous effect described for the first embodiment. As noted for the first embodiment, likewise, it is necessary to carry out a large number of simulations for advance preparation. However, creating a library is necessary only once for each product manufacturing process and recalculation is not required later.

### Third Embodiment

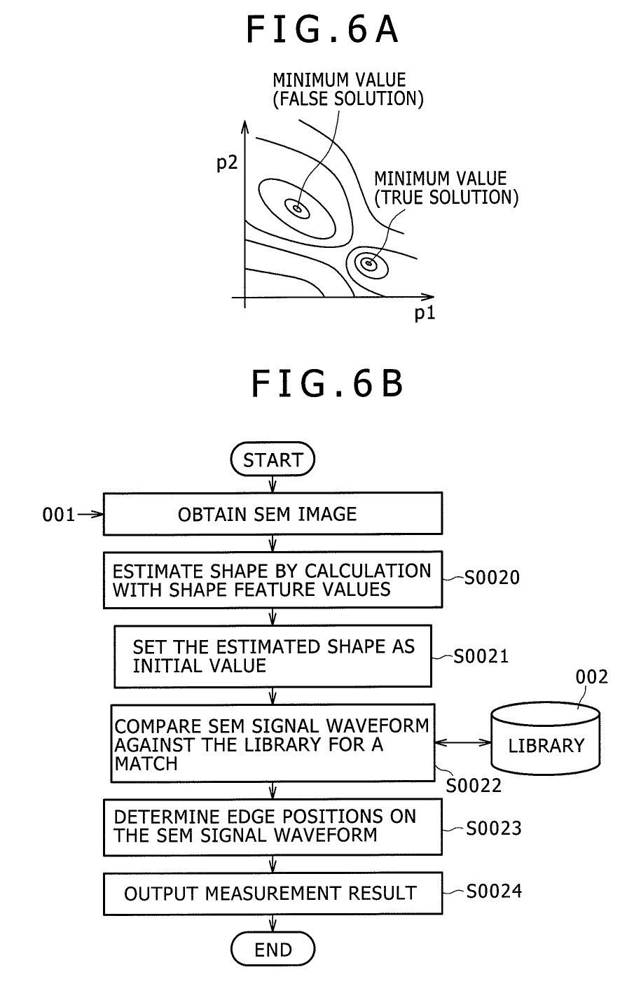

In the third embodiment, in a case where nonlinear optimization is used for waveform matching against the library, a means for stable and fast matching is described using FIGS. 6 through 8. FIG. 6A illustrates a problem associated with library matching and the graph represents a matching error space (a relationship between geometry parameters and matching errors). Although the graph is presented with regard to only two geometry parameters p1, p2 (e.g., sidewall inclination angle and top corner rounding) for simplifying purposes, in practice, such space may be a multidimensional space involving a number of parameters.

The contour map represents matching errors (e.g., the sum of squares of difference) between an actually measured SEM image of a target and a simulated waveform with regard to a set of parameters. In an ideal case, it is desirable that this map has only one minimum value of which the error is sufficiently smaller than its periphery. In practice, however, the map may have a plurality of minimum values as shown in FIG. 6A due to image noise and an imperfect model. In such a case, there is a possibility that a false solution is selected in matching processing by nonlinear optimization. In some case, a false solution could have a smaller error and even if a mathematically right solution is selected, the measurement result becomes wrong.

In general, initial value setting is important for nonlinear optimization. If initial values near to a solution are set properly, a right solution becomes easy to obtain. Conversely, if improper initial values are given, this poses such problems that a wrong solution is selected and that it takes much time for convergence. Thus, in the third embodiment, initial values are set to proper values by estimating SEM image feature values of an actual pattern.

The third embodiment is described using FIG. 6B. In the procedure of FIG. 6B, steps S0022 to S0024 are the same as in the procedure in FIG. 1B for the first embodiment, except that steps S0020, S0021 replaces the steps S0002, 0003. In the present embodiment, after obtaining a SEM image, the shape of a target pattern being measured is estimated by using SEM image feature values (S0020). Then, the cross-sectional shape estimated in the step S0020 is set as an initial value for nonlinear optimization (S0021). The actually measured SEM image is compared to the simulated waveforms in the library for a match (S0022), the measurement result is obtained (S0023), and the result is output (S0024)

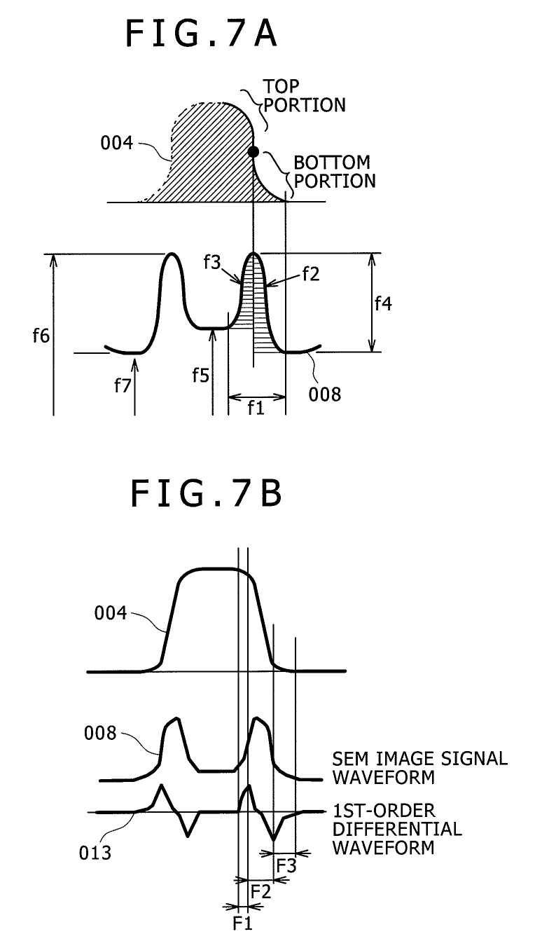

Examples of image feature values which are used in the step S0020 are shown in FIGS. 7A and 7B. In FIG. 7A, a feature value f1 is the width of an edge peak portion (hereinafter called a white band). The white band width is the feature value reflecting an expected width of the edge portion from a vertically overhead view. A feature value F2 is an average width of an outer portion of the white band from the peak position and reflects how large the curvature of the bottom portion is. A feature value f3 is an average width of an inner portion of the white band from the peak position and reflects how large the curvature of the top portion is. A feature value f4 is signal amplitude and reflects how large the taper angle is, as can be seen in FIGS. 7A and 7B. In the case of a system that is able to estimate an absolute signal quantity, an absolute signal quantity f6 at the peak and a minimum absolute signal quantity F7 outside each edge can be used. The value of f6 varies depending on the taper angle because of an inclination angle effect and the value of f7 varies depending on space.

FIG. 7B presents other examples of feature values. Using first-order differential of an edge peak portion, distances between points having ultimate values of first-order differential and each ultimate point and a zero point are represented as feature values F1, F2, F3. The value of F1 varies depending on the curvature of the top corner, the value of F2 correlates with sidewall inclination angle, and the value of F3 correlates with bottom extension. Various feature values as shown in FIGS. 7A and B are calculated beforehand for simulated waveforms in the library. The same feature values are calculated for an actual SEM signal waveform when measurement is performed. From relationships between actual and simulated feature values, the shape of the target pattern being measured is estimated, the result is set as an initial value, and library matching is performed.

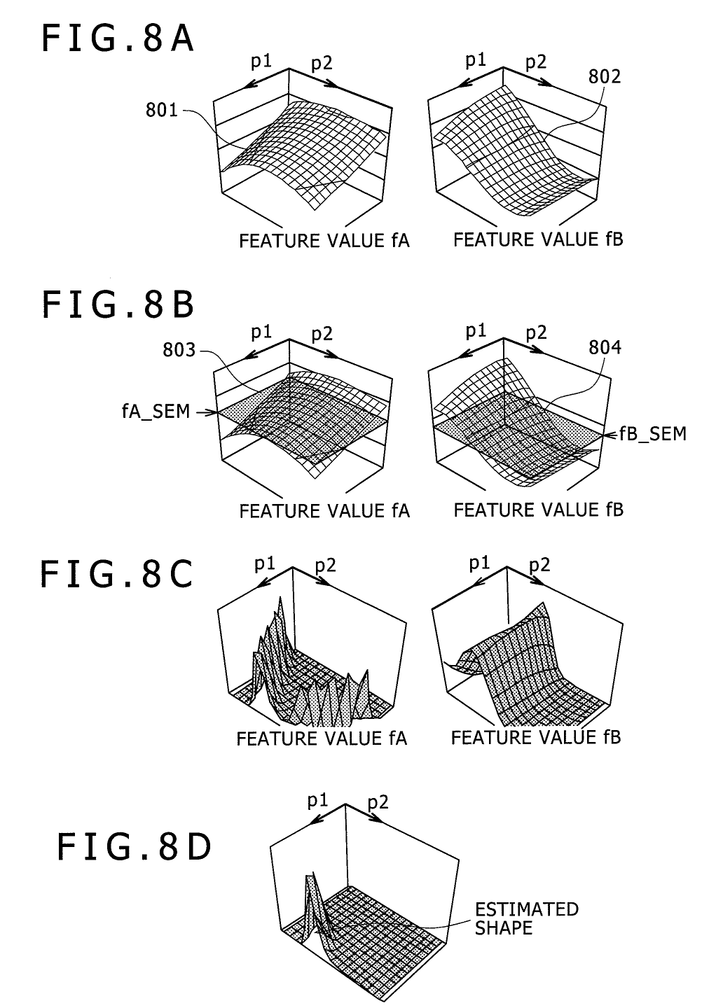

Next, a method for estimating pattern geometry parameters from these feature values is described using FIGS. 8A-8D. FIG. 8A presents graphs plotting distribution of image feature values in a geometry parameter space on curved surfaces 801 and 802. p1 and p2 are geometry parameters of a simulation shape model, such as sidewall inclination angle and corner curvature. Feature values fA, fB represent SEM image feature values as exemplified in FIGS. 7A and 7B. To simplify explanation, two geometry parameters and two feature values are taken by way of example. In practice, however, more geometry parameters and feature values may be used, of course (in that case, another parameter space in four or more dimensions may be provided).

The graphs shown in FIG. 8A can be obtained by calculating various feature values as exemplified in FIG. 7A and 7B for simulated waveforms in the library and, therefore, need not to be created when measurement is performed. In advance, these graphs are created together with the library. Then, when image feature values fA_SEM, fB_SEM are calculated from an actual SEM image obtained by measurement, planes 803 and 804 shown in FIG. 8B are obtained. Geometry parameters corresponding to intersection points between a curved surface 801 or 802 on which feature values from the library are plotted and a plane 803 or 804 become candidates to estimate the shape of the target pattern being measured.

Then, as shown in FIG. 8C, a likelihood function of each parameter according to a distance from the plane is given appropriately. In FIG. 8C, since each parameter has most likely values, most likely points can be calculated by combining the graphs in FIG. 8C. Thereby, the geometry parameters of the actual SEM image can be estimated as shown in FIG. 8D. The thus estimated geometry parameters are used as initial values and library matching is performed, so that stable and fast matching processing can be performed without mischoosing a false solution. Consequently, it becomes possible to estimate pattern shape and dimension in a stable, fast and highly accurate manner. In addition to the method of setting these initial values, of course, parameters of the apparatus such as detector gain, offset, and beam diameter may be set beforehand by such a method as disclosed in patent document 2. After setting apparatus parameters to proper values, by appropriately setting the initial values of pattern geometry parameters, stable and fast pattern measurement can be accomplished.

As described above, the third embodiment of the present invention, if applied, can achieve stable and fast measurements of pattern shapes and dimensions.

### Fourth Embodiment

In the third embedment, initial values for estimating a pattern shape are set using feature values obtained from a SEM image. In the fourth embodiment, these initial values are set using measurements obtained by another measurement apparatus. In the present embodiment, a method of using AFM measurements in combination with SEM is described. Because AFM has a relatively low throughput, AFM is not suitable for a large amount of measurements, but it can acquire data enough to only estimate a rough shape of a pattern through a few scans. Thus, in the present embodiment, the target pattern being measured is measured by AFM beforehand. Based on the thus obtained cross-section profile shape of the pattern, initial values of geometry parameters are set or a range of geometry parameter values corresponding to the scope of matching is set.

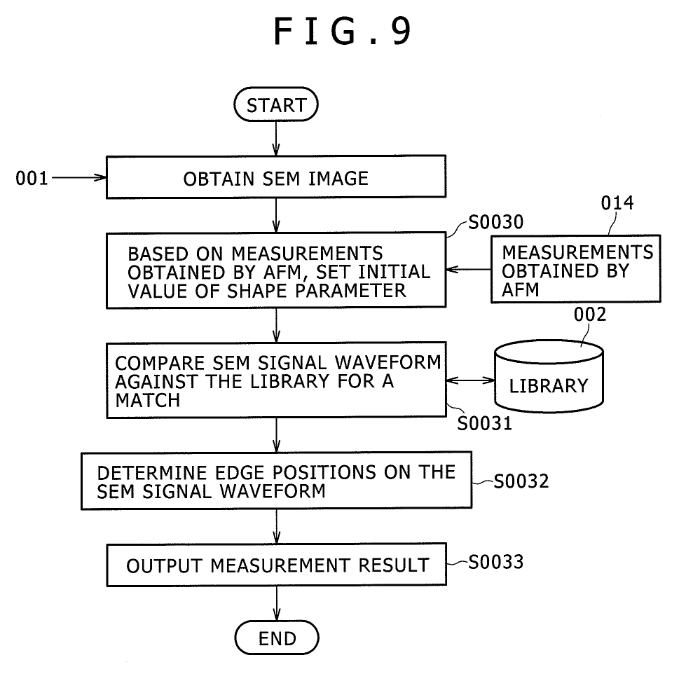

The procedure is shown in FIG. 9. In the procedure of FIG. 9, steps S0031 to S0033 correspond to S0004 to S0006 in the procedure described in FIG. 1B for the first embodiment, except that step S0030 replaces the steps S0002, S0003 described in FIG. 1B. After obtaining a SEM image of a target being measure, from measurements previously obtained by AFM, values corresponding to geometry parameters used in a simulation model are directly derived and results are set as initial values for library matching (S0030). For example, linear fitting on height measurements of each edge is performed and, from its inclination, the sidewall inclination angle of the edge can be obtained. Subsequently, using these initial values, the actual SEM waveform is compared against the library of simulated waveforms for a match (S0031), dimension measurement is performed (S0032), and the measurement result is output (S0033). In this way, stable and fast measurements can be performed as in the third embodiment.

In the step S0030 in FIG. 9, initial values of geometry parameters are determined based on measurements obtained by AFM. Also, this step may include limiting a range of parameter values corresponding to the scope of matching. Limiting the proper scope of matching within which parameter values are estimated can reduce the possibility of choosing a wrong solution in matching. In this way, stable and fast measurements can be performed as in the third embodiment.

In SEM image evaluation, it is generally difficult to know pattern height variation. Because height information can be obtained by using AFM data, simulated waveforms for varying heights may be prepared in the library like those for space width variation in the first embodiment. The scope of matching in the library may be limited to waveforms for a height obtained and measurement performed. In this case, in the step S0030, a height parameter is fixed instead of initial values. In the present invention, stable and highly accurate measurements even for patterns with varying heights can be accomplished by combination of AFM and SEM. Although the case where AFM is used is discussed in the present embedment, the same effect can also be obtained by using optical pattern shape measurement apparatus such as Scatterometry.

### Fifth Embodiment

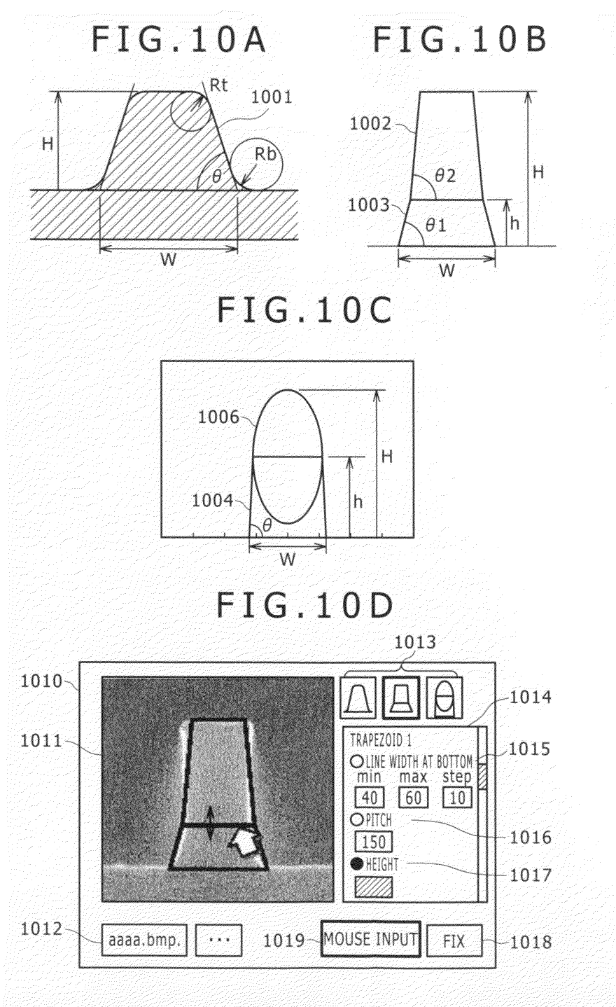

Next, a method for creating a library of simulated waveforms for use in the pattern measurement method of the present invention is described as a fifth embodiment, using FIGS. 10A-10D.

When creating a library of simulated waveforms, a pattern shape model is determined and shapes are numerically expressed by parameters that are used in the model. For example, in the example of FIG. 4B, shapes are expressed using a variable parameter of sidewall inclination angle θ. FIG. 10A presents an extension of the above example and bottom corner rounding Rb of a pattern shape model 1001 is used as an additional parameter. It is desirable that this pattern shape model 1001 is analogous to an actual pattern shape variation that may occur in a process under measurement.

For example, considering an etching process, when etching condition varies, the shape of top corner Rt does not change much because it is protected by resist mask pattern, but the sidewall shape is susceptible to etching condition variation and pattern width W is prone to change. Especially, in a case that selectivity of a stopper layer is not good, etching condition changes in the vicinity of the bottom and, consequently, the sidewall shape often changes at a height at which etching condition change occurs. In such a case, a shape model in which one trapezoid 1002 is on top of another trapezoid 1003, as shown in FIG. 10B, is suitable for expressing an actual pattern. In this case, for example, an entire height H is determined by a deposition process and does not change with the etching process. Hence, in etching pattern evaluation, it will be advisable to fix H to a design value or set H to a value previously measured by a film thickness meter. As for a change point height h at which the etching process changes, it will be advisable to determine an approximate value of h from a cross-section photograph of an actual pattern.

By fixing some parameters in the shape model to values suitable for a process to be evaluated in this way, the parameters to be estimated in library matching can be reduced and stable and fast measurements can be performed. FIG. 10C presents an example of a shape model suitable for resist patterns, made by a combination of a trapezoid 1004 and an ellipse 1005, wherein the vertices of the trapezoid contact the sidewalls. For example, by specifying H and h beforehand, W is given as a fixed value and the ellipse 1005 is uniquely determined only by setting θ. Hence, only θ is a parameter to be estimated and estimating top rounding Rt is not needed.

FIG. 10D is an example of a graphical user interface allowing the user to select such a model and set parameters, while viewing a cross-section photograph. Viewing the cross-section SEM photograph of the pattern, the operator can easily determine, for example, h in FIG. 10B. When creating a library, if the operator displays a cross-section SEM photograph 1011 which has been obtained beforehand on the screen 1010 and superimposes a model shape on the SEM photograph, the operator can easily set geometry parameters, while viewing the screen 1010, by operating a mouse.

In the example of FIG. 10D, a cross-section image to be used is selected using a button 1012 appearing at bottom left of the screen 1010 and a model to be used is selected from among thumbnail images 1013 at top right. Then, in the right main area 1014 of the screen 10101, which geometry parameters in the selected model are fixed and a range of values can be specified (in FIG. 10D, line width at bottom 1015, pitch 1016, and height 1017 are specified by way of example). After selecting the parameters and pressing the fix button 1018, when the mouse input button 1019 is pressed, the target parameters can be set to arbitrary values. In this way, a library of simulated waveforms can be created based on selection of a suitable model for practical a process and setting of a range of values of parameters.

Although FIG. 10D presents the example of a cross-section SEM photograph, a STEM photograph and measurements obtained by AFM may be used instead, of course. Such cross-section information taking a variation range in a practical process into consideration is desirable. For example, as for resist patterns, by creating a plurality of patterns irradiated with a beam, wherein the focus and the irradiation energy amount vary, and by preparing patterns having threshold conditions with respect to a normal range of the process, it is possible to create a library of simulated waveforms covering pattern shapes which may occur in the process.

Selecting a model suitable for a process and selecting parameters to be estimated, if can be carried out appropriately, will improve the degree of agreement between a simulated waveform and an actual SEM waveform and enable more accurate and stable measurements. Rather than estimating all parameters, by fixing a parameter not affected by process variation and thus reducing the number of parameters to be estimated, advantageous effects such as reduced calculation time for estimation and stable estimation results can be obtained.

### Sixth Embodiment

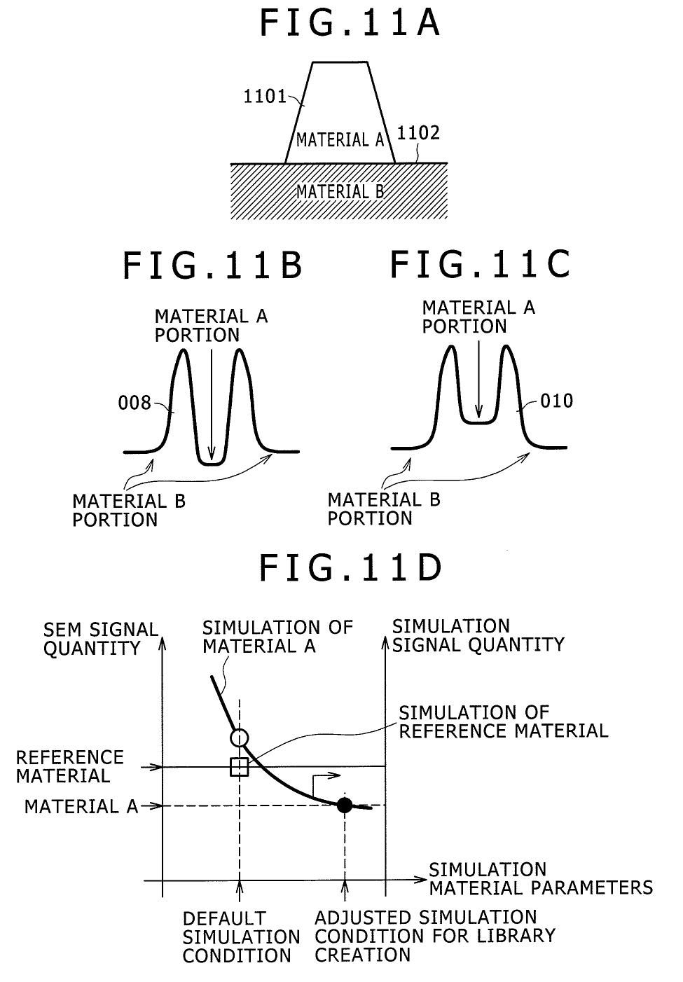

Using FIGS. 11A-11D, a description is provided as to a method for setting material parameters when creating a library of simulated waveforms for use in the pattern measurement method of the present invention.

The signal quantity of secondary electrons detected by SEM changes depending on SEM image capturing conditions such as an accelerating voltage of an irradiation beam and scan speed and the material of a target being measured. However, it is difficult to exactly simulate signal quantity differences depending on material. It often happens that, for example, as for a pattern made of silicon dioxide, different deposition methods used to form the pattern result in different SEM signal quantities.

Meanwhile, relative SEM signal waveform change depending on shape variation of a pattern of the same material can be simulated relatively exactly, even if difference depending on material is not reproducible exactly. Hence, higher measurement accuracy than conventional methods can be achieved in the measurement of the present invention based on matching with simulated waveforms. However, as shown in FIGS. 11A-11C, in the case of using a SEM image of a sample in which a pattern and a substrate surface layer are made of different materials, it becomes hard to perform measurement with high accuracy.

Because of signal quantity change of secondary electrons depending on material, for example, as shown in FIG. 11A, the signal quantity at the top of a pattern 1101 made of material A differs from the signal quantity in the substrate surface layer made of material B. For example, if a SEM image signal waveform of the pattern 1101 in FIG. 11A is as shown in FIG. 11B, simulation may produce a simulated waveform as shown in FIG. 11C. In this case, because of contrast inversion between the material A portion and the material B portion, it is impossible to create a simulated waveform matching an actual image no matter how geometry parameters in the library are adjusted, and consequently it becomes difficult to obtain accurate measurement results.

In the present invention, when such a sample is measured, by adjusting material parameters in advance, it is possible to improve the measurement accuracy based on library matching. Although depending on the model to be used, ordinary SEM simulators have material-related setting parameters. Such a parameter is adjusted beforehand in the present invention. For example, as disclosed in non-patent document 3, for example, a SEM simulator MONSEL has a parameter called a residual energy loss rate for adjusting energy attenuation due to scattering of electrons. By adjusting this parameter, the signal quantity of secondary electrons developed changes. Simulators using other models usually have a parameter similar to the above-mentioned parameter. If SEM includes hardware capable of measuring an absolute secondary electron emission efficiency (a ratio of secondary electrons to irradiance of primary electrons), material parameters should be adjusted in advance before creating a library so that a simulation result accords with the measured secondary electron emission efficiency.

In general, it is, however, difficult to measure an absolute secondary electron emission efficiency in SEM and material parameter adjustment for SEM simulation is not easy. In such as case, a reference material is defined and parameters are set so that, in terms of the ratio of SEM signal quantity to the reference material, there is a match between an actual image and simulation.

For example, in the case of FIG. 11A, for example, the signal quantity of the material A is adjusted relative to the material B of the substrate surface layer. First, in the region of a relatively large pattern such as a scribe line, for each material A, B, a SEM image of a flat section away from edges is actually obtained. Then, a SEM image is captured with primary electron irradiation on the sample being stopped by, for example, closing a valve between a column and a sample chamber. Thereby, a SEM image (dark current) with no incoming signal on the sensor is obtained. At this time, it is assured that the SEM images of the materials A, B and the SEM image in the state of no beam irradiation are all obtained under the same detection conditions (such as beam condition and detector sensitivity). Then, an average brightness in a suitable region in each image is calculated and a dark current brightness is subtracted from the brightness of each material A, B. After that, a relative signal quantity of the material A to the reference material B is calculated and parameters of the material A are adjusted so that a simulation result accords with the relative signal quantity.

FIG. 11D presents an example of adjustment. Actual signal quantity which has been measured beforehand is plotted on the left y axis. In this example, the signal quantity of the material A is about 60% of the signal quantity of the reference material. Under a default simulation condition, first, secondary electron emission efficiencies of the material A and the reference material B are calculated (results are marked with a white circle and a white box). In FIG. 11D, the right y axis is also drawn so that the result of the reference material B (white box) accords with the actual image. In this simulation result, the material A is brighter, which differs from the actual image. Then, some material parameters of the material A are altered and its secondary electron emission efficiency is calculated, the result of which corresponds to a curved line. A condition in which the brightness of the material A to the reference material accords with the actual image is marked with a black circle.

In this way, by adjusting a relative brightness between materials so that the contrast between the materials accords with the actual image, library matching can be performed stably and with high accuracy, although not perfectly. As the reference material, a stable material having well-known properties is desirable. As for a semiconductor wafer, typically, Si that is the material of the substrate can be used.

In this way, by setting material parameters to proper values beforehand, it is possible to improve consistency with simulation. Consequently, it becomes possible to improve stability and accuracy of measurements in the pattern measurement method using a library of simulated waveforms.

As in the fourth embodiment, if a rough shape of a pattern can be measured by another measurement apparatus, it is possible to set material parameters based on signal quantities in edge portions along with brightness measurements in flat sections. In the case of the pattern shown in FIG. 11A, for example, its rough shape is first measured by AFM. Based on the result of AFM measurement, measurements obtained by AFM are input to render the pattern shape and simulation is performed with several material parameters. A parameter for which a relationship between the signal quantity in the flat section (top surface) of the material A and the signal quantity at each sidewall of the material A accords with the actual SEM image is selected. Then, a parameter of the material B for which these signal quantities in the flat section and edge portion of the material A accord with the actual SEM image is determined.

According to the present invention, simulated waveforms are obtained in which the relationship between the signal quantity in an edge portion and the signal quantity in a flat section is close to an actual image and it becomes possible to further improve the stability and accuracy of measurements. Application of this method enables adjusting and reflecting material parameters in simulation even if no reference sample exists.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method for measuring a pattern dimension using a SEM image, the method comprising the steps of:
performing SEM simulation with parameters of a pattern shape, dimension, and space distances to neighboring patterns;
storing simulated waveforms obtained by the SEM simulation in a library;
obtaining a SEM image of a target pattern being measured;
determining feature values of the target pattern by processing the obtained SEM image;
based on the determined feature values of the target pattern, selecting a group of simulated waveforms meeting the feature values of said target pattern from said library as the waveforms for use in matching;
comparing a signal waveform obtained from the SEM image of the target pattern to the selected group of simulated waveforms for matching in the library for a match and estimating shape information of said target pattern from the most matched simulated waveform;
calculating the dimension of said target pattern based on the estimated shape information of the target pattern; and
displaying the estimated shape information and the calculated pattern dimension information along with the SEM image on a screen or outputting numerical data thereof.

2. The method of claim 1, wherein the feature values of the target pattern determined by processing said SEM image are the space distances from the target pattern to its neighboring patterns or the dimension of the target pattern.

3. The method of claim 1, wherein said SEM simulation is performed by modeling an approximate shape of the target pattern with numerical data beforehand and specifying a combination of a plurality of different sidewall shapes, dimensions, and distances between neighboring patterns corresponding to a scope of measurement of the pattern shape as input geometry parameters.

4. A method for measuring a pattern dimension using a SEM image, the method comprising the steps of:
performing SEM simulation with parameters of a pattern shape, dimension, and space distances to neighboring patterns and storing simulated waveforms obtained by the SEM simulation in a library;
calculating a plurality of image feature values from results of the simulation and storing relationships between a plurality of input geometry parameters and the image feature values;
obtaining a SEM image of a target pattern being measured and calculating feature values of the target pattern by processing the obtained SEM image;
estimating geometry parameters of the target pattern using the calculated image feature values and the relationships between the input geometry parameters and the image feature values;
determining a simulation condition in which a simulated waveform most matches the SEM image from library data using information of the estimated geometry parameters which are input; and
estimating the cross-sectional shape and dimension of the target pattern according to the simulation condition.

5. The method of claim 4, wherein said step of determining a simulation condition in which a simulated waveform most matches the SEM image from library data comprises setting the information of the estimated geometry parameters as initial values and determining a simulation condition in which a simulated waveform most matches the SEM image from the library data by a nonlinear optimization method.

6. The method of claim 4, wherein said SEM simulation is performed by modeling an approximate shape of the target pattern with numerical data beforehand and specifying a combination of a plurality of different sidewall shapes, dimensions, and distances between neighboring patterns corresponding to a scope of measurement of the pattern shape as input geometry parameters.

7. A method for measuring a pattern dimension using a SEM image, the method comprising the steps of:
performing SEM simulation with parameters, a shape and dimension of a target pattern being measured and space distances to neighboring patterns, and storing simulated waveforms obtained by the SEM simulation in a library;
measuring an approximate cross-sectional shape of said target pattern by using a measuring apparatus;
calculating input geometry parameters from the measured approximate cross-sectional shape;
obtaining a SEM image of said target pattern;
determining a simulation condition in which a simulated waveform most matches the obtained SEM image signal waveform from library data using information of the calculated input geometry parameters; and
estimating the cross-sectional shape and dimension of the target pattern from the simulation condition.

8. The method of claim 7, wherein, in said step of measuring an approximate cross-sectional shape of said target pattern, said approximate cross-sectional shape is the shape measured by using AFM or Scatterometry.

9. The method of claim 7, wherein said step of determining a simulation condition in which a simulated waveform most matches the SEM image from library data comprises setting the information of the calculated geometry parameters as initial values and determining a simulation condition in which a simulated waveform most matches the SEM image from the library data by a nonlinear optimization method.

10. The method of claim 7, wherein said SEM simulation is performed by modeling an approximate shape of the target pattern with numerical data beforehand and specifying a combination of a plurality of different sidewall shapes, dimensions, and distances between neighboring patterns corresponding to a scope of measurement of the pattern shape as input geometry parameters.

11. Apparatus for measuring a pattern dimension using a SEM image, the apparatus comprising:
simulation means for performing SEM simulation with parameters of a pattern shape, dimension, and space distances to neighboring patterns and storing simulated waveforms obtained by the SEM simulation in a library;
SEM image processing means for processing a SEM image of a target pattern being measured, obtained by a SEM apparatus, and determining feature values of the target pattern;
matchable waveforms selecting means for, based on the feature values of the target pattern determined by the SEM image processing means, selecting a group of simulated waveforms meeting the feature values of said target pattern from the library of said simulation means as the waveforms for use in matching;
pattern shape estimating means for comparing a signal waveform obtained from the SEM image of the target pattern to the group of simulated waveforms for matching selected by the matchable waveforms selecting means in the library for a match and estimating shape information of said target pattern from the most matched simulated waveform;
pattern dimension calculating means for calculating the dimension of said target pattern based on the shape information of the target pattern estimated by the pattern shape estimating means; and
output means for displaying the shape information estimated by said pattern shape estimating means and the pattern dimension information calculated by said pattern dimension calculating means along with the SEM image on a screen or outputting numerical data thereof.

12. The apparatus of claim 11, wherein the feature values of the target pattern determined by processing the SEM image by said SEM image processing means are the space distances from the target pattern to its neighboring patterns or the dimension of the target pattern.

13. The apparatus of claim 11, wherein said simulation means performs said SEM simulation by modeling an approximate shape of the target pattern with numerical data beforehand and specifying a combination of a plurality of different sidewall shapes, dimensions, and distances between neighboring patterns corresponding to a scope of measurement of the pattern shape as input geometry parameters.

14. Apparatus for measuring a pattern dimension using a SEM image, the apparatus comprising:
simulation means for performing SEM simulation with parameters of a pattern shape, dimension, and space distances to neighboring patterns and storing simulated waveforms obtained by the SEM simulation in a library;
image feature values calculating means calculating a plurality of image feature values from results of simulation performed by the simulation means and storing relationships between a plurality of input geometry parameters and the image feature values;
pattern geometry parameters estimating means for calculating image feature values in a SEM image of a target pattern being measured, obtained by a SEM apparatus, and estimating geometry parameters of the target pattern using the calculated image feature values and the relationships between the input geometry parameters and the image feature values;
simulation condition determining means for determining a simulation condition in which a simulated waveform most matches the SEM image from library data using information of the geometry parameters which are input estimated by the pattern geometry parameters estimating means; and
pattern cross-sectional shape and dimension estimating means for estimating the cross-sectional shape and dimension of the target pattern according to the simulation condition determined by the simulation condition determining means.

15. The apparatus of claim 14, wherein said simulation condition determining means sets the information of the geometry parameters estimated by said pattern geometry parameters estimating means as initial values and determines a simulation condition in which a simulated waveform most matches the SEM image from the library data by a nonlinear optimization method.

16. The apparatus of claim 14, wherein said simulation means performs said SEM simulation by modeling an approximate shape of the target pattern with numerical data beforehand and specifying a combination of a plurality of different sidewall shapes, dimensions, and distances between neighboring patterns corresponding to a scope of measurement of the pattern shape as input geometry parameters.

17. Apparatus for measuring a pattern dimension using a SEM image, the apparatus comprising:
simulation means for performing SEM simulation with parameters of a pattern shape, dimension, and space distances to neighboring patterns and storing simulated waveforms obtained by the SEM simulation in a library;
approximate cross-sectional shape information input means for inputting approximate cross-sectional shape information of said target pattern obtained by using a measuring device;
input geometry parameters calculating means for calculating input geometry parameters from the approximate cross-sectional shape information input to the approximate cross-sectional shape information input means;
simulation condition determining means for, upon receiving a SEM image of a target pattern being measured, obtained by a SEM apparatus, determining a simulation condition in which a simulated waveform most matches the SEM image signal waveform of the target pattern from library data of said simulation means using information of the input geometry parameters calculated by said input geometry parameters calculating means; and
pattern cross-sectional shape and dimension estimating means for estimating the cross-sectional shape and dimension of the target pattern from the simulation condition determined by the simulation condition determining means.

18. The apparatus of claim 17, wherein said simulation condition determining means sets the information of the input geometry parameters calculated by said input geometry parameters calculating means as initial values and determines a simulation condition in which a simulated waveform most matches the SEM image from the library data by a nonlinear optimization method.

19. The apparatus of claim 17, wherein said rough cross-sectional shape information input means inputs an approximate cross-sectional shape of the target pattern determined by using AFM or Scatterometry as said rough cross-sectional shape.

20. The apparatus of claim 17, wherein said simulation means performs said SEM simulation by modeling an approximate shape of the target pattern with numerical data beforehand and specifying a combination of a plurality of different sidewall shapes, dimensions, and distances between neighboring patterns corresponding to a scope of measurement of the pattern shape as input geometry parameters.
